(19) United States
(12) Patent Application Publication
(10) Pub. No.: US 2006/0179286 A1
(43) Pub. Date: Aug. 10, 2006

(54) System and method for processing limited out-of-order execution of floating point loads

(75) Inventors: Juergen Haess, Schoenaich (DE); Michael Kroener, Ehningen (DE); Dung Quoc Nguyen, Austin, TX (US); Eric M. Schwarz, Gardiner, NY (US); Son Dao-Trong, Stuttgart (DE); Raymond C. Yeung, Round Rock, TX (US)

Correspondence Address: CANTOR COLBURN LLP-IBM POUGHKEEPSIE, 55 GRIFFIN ROAD SOUTH, BLOOMFIELD, CT, 06002, US

(73) Assignee: International Business Machines Corporation, Armonk, NY (US)

(21) Appl. No.: 11/054,201

(22) Filed: Feb. 9, 2005

(51) Int. Cl. G06F 9/44

(52) U.S. Cl. 712/225

(57) ABSTRACT

A system for performing limited out-of order execution of floating point loads. The system includes a plurality of stages making up a pipeline, the stages including an early stage. The system also includes a mechanism for inputting an arithmetic instruction into the pipeline, the arithmetic instruction including a result address. The mechanism also determines if the arithmetic instruction causes a write after write (WAW) condition to occur before writing a result of the arithmetic instruction to the result address. The determining includes comparing the result address to a load address associated with a load instruction subsequent to the arithmetic instruction in the pipeline. The load data associated with the load instruction was written to the load address in the early stage of the pipeline. A WAW condition occurs if the result address is equal to the load address. Writing a result of the arithmetic instruction is suppressed in response to the WAW condition occurring.

### TRADEMARKS

IBM® is a registered trademark of International Business Machines Corporation, Armonk, N.Y., U.S.A. S/390, Z900 and z990 and other names used herein may be registered trademarks, trademarks or product names of International Business Machines Corporation or other companies.

### BACKGROUND OF THE INVENTION

This invention relates to computer systems that execute floating point instructions, and more particularly, to a method and system for processing limited out-of-order execution of floating point loads.

A floating point unit typically consists of several pipeline stages, such as multiple pipeline stages for arithmetic computation (e.g., addition and multiplication), a normalization stage, and a rounding stage. Each pipeline stage may contain a separate instruction and the stages are connected in an ordered manner. As an instruction enters the pipeline, the necessary input data operands are accessed and are put into the first stage of the pipeline. The instruction advances from stage to stage within the pipeline as permitted. An instruction is considered to “stall” within the pipeline when forward progress is not allowed. An instruction is not permitted to advance to a new stage in the pipeline when the successive pipeline stage contains another previous instruction that itself cannot advance. An instruction cannot commence to operate until it has data to operate on. It may not have data to operate upon when an earlier instruction will update the data that a successive instruction will operate upon. This is referred to as a data dependency. For this reason, the successive instruction will “stall” at the entrance to the pipeline until it receives the updated data. When each instruction is executed in the order in which it is received in the pipeline, the system may be referred to as an “in-order” processing system. In order execution in a microprocessor simplifies the design of the multiprocessor, but it may result in poorer performance than that achieved by “out-of-order” processing systems that allow instructions to be executed in a different order than they are received in the pipeline.

It would be desirable to not only be able to utilize the simplified design of an in-order processing system but to also allow an out-of-order execution of floating point loads to provide data to arithmetic instructions as early as possible. This would result in a smaller elapsed time for the arithmetic instruction because the arithmetic instruction would not have to wait for the previous load instruction to complete before beginning execution.

### BRIEF SUMMARY OF THE INVENTION

Exemplary embodiments of the present invention include a system for performing limited out-of order execution of floating point loads. The system includes a plurality of stages making up a pipeline, the stages including an early stage. The system also includes a mechanism for inputting an arithmetic instruction into the pipeline, the arithmetic instruction including a result address. The mechanism also determines if the arithmetic instruction causes a write after write (WAW) condition to occur before writing a result of the arithmetic instruction to the result address. The determining includes comparing the result address to a load address associated with a load instruction subsequent to the arithmetic instruction in the pipeline. The load data associated with the load instruction was written to the load address in the early stage of the pipeline. A WAW condition occurs if the result address is equal to the load address. Writing a result of the arithmetic instruction is suppressed in response to the WAW condition occurring.

Additional exemplary embodiments include a method for performing floating point arithmetic operations. The method includes inputting an arithmetic instruction into a pipeline. The arithmetic instruction includes a result address and the pipeline with a plurality of stages including an early stage. Before writing a result of the arithmetic instruction to the result address, a determination is made to see if the arithmetic instruction causes a write after write (WAW) condition to occur. The determining includes comparing the result address to a load address associated with a load instruction subsequent to the arithmetic instruction in the pipeline. The load data associated with the load instruction was written to the load address in the early stage of the pipeline. A WAW condition occurs if the result address is equal to the load address. Writing a result of the arithmetic instruction is suppressed in response to the WAW condition occurring.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a seven stage pipeline that has been utilized by prior art to allow arithmetic instructions to be executed one or more cycles after a dependent load instruction enters the pipeline;

FIG. 2 depicts another seven stage pipeline that has been utilized by prior art to allow arithmetic instructions to be executed one or more cycles after a dependent load instruction enters the pipeline;

FIG. 3 depicts an exemplary pipeline that may be utilized by exemplary embodiments of the present invention to allow load instructions to be executed early in the pipeline and to prevent a write after write (WAW) from occurring; and

FIG. 4 depicts an exemplary WAW suppression block that may be utilized by exemplary embodiments of the present invention.

The detailed description explains the preferred embodiments of the invention, together with advantages and features, by way of example with reference to the drawings.

### DETAILED DESCRIPTION OF THE PREFERRED EMBODIMENTS

Exemplary embodiments of the present invention detect dependencies between loads and arithmetic operations, and allow load dependencies to be immediately resolved. Dependencies are immediately resolved by bypass paths or by allowing subsequent instructions to read directly from the floating point register and not marking the dependency. Allowing load dependencies to be immediately resolved causes a problem ordering the loads with the arithmetic instructions because the load instructions are being issued in order but completing out-of-order. In particular, there is a “write after write” (WAW) hazard. For example, a multiply instruction that writes to FPR5 (floating point register five) may get issued before a load to FPR5, but the load writes to FPR5 early. In this case, exemplary embodiments of the present invention include an issue queue that detects the WAW hazard and sends a signal to the floating point unit (FPU) to block the write of the multiply instruction. The multiply instruction still updates the floating point state and control register (FPSCR) but does not update the register file.

Exemplary embodiments of the present invention include limited out-of-order execution of floating point loads. The term limited out-of-order execution of floating point loads, as used herein, refers to an in-order processing system with loads being written to an FPR in an early cycle (i.e. not waiting to the end of the pipeline to write to the FPR). All other instructions in the pipeline are executed in order. The mechanism to perform this limited out-of-order execution of floating point loads resolves dependencies in the issue queue early and also detects for WAW hazards. The FPU writes loads in an early pipeline stage and also has a mechanism for blocking writes due to WAW hazards.

A sample instruction stream for input to a seven stage pipeline follows:

| | | | |
|---|---|---|---|
| Instruction | 1.1 | lfd fpr5, (mem1) | fpr5 [symbol] (mem1) |
| | 1.2 | fmadd fpr5, fpr1, fpr2, fpr5 | fpr5 [symbol] [(fpr1) × (fpr2)] + |
| | | | (fpr5) |
| | 1.3 | stfd fpr5, (mem2) | mem2 [symbol] (fpr5) |
| | 2.1 | lfd fpr5, (mem1 + disp) | fpr5 [symbol] (mem1 + disp) |
| | 2.2 | fmadd fpr5, fpr1, fpr2, fpr5 | fpr5 [symbol] [(fpr1) × (fpr2)] + |
| | | | (fpr5) |
| | 2.3 | stfd fpr5, (mem2 + disp) | mem2 + disp [symbol] (fpr5) |

In the above instruction stream it would be desirable for the load instructions (e.g., lfd instruction 1.1) to be performed early, for example in the first stage of the pipeline rather than the seventh, so that an arithmetic instruction (e.g., a fused multiply add instruction such as fmadd instruction 1.2) may utilize the data from the load without having to wait seven cycles for the load instruction to complete. In addition, it would be desirable to avoid having the fmadd instruction 1.2 overwrite (e.g., in cycle 7) the value loaded into FPR5 by the second load instruction (i.e. lfd instruction 2.1). Several approaches may be taken to executing floating point loads in a pipeline while still being able to start dependent instructions.

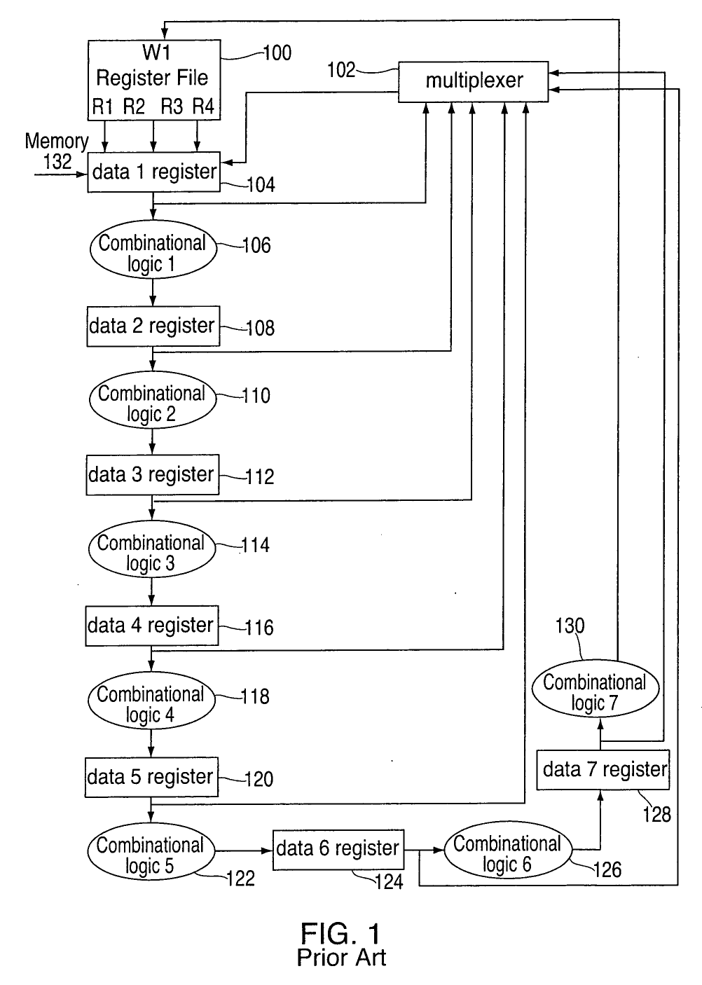

FIG. 1 depicts a seven stage pipeline that has been utilized by prior art to allow arithmetic instructions to be executed one or more cycles after a dependent load instruction enters the pipeline. Instructions are received (e.g., from a control unit) into a register file 100. The pipeline includes a typical seven stage pipeline with a data one register 104, combinatorial logic one 106, a data two register 108, combinatorial logic two 110, a data three register 112, combinatorial logic three 114, a data four register 116, combinatorial logic four 118, a data five register 120, combinatorial logic five 122, a data six register 124, combinatorial logic six 126, a data seven register 128, and combinatorial logic seven 130. The pipeline flow includes data from the register file 100, data from memory 132 and data from a multiplexer 102 entering the data one register 104. The feedback paths from each of the data registers (e.g., data one register 104, data two register 108 and data seven register 128) to the multiplexer 102 are utilized to provide access to load operands when they are being staged through the pipeline before they appear in the register file 100 when the load operation has completed (see the arrow from combinatorial logic seven 130 to the register file 100).

In this manner, an arithmetic instruction does not have to wait for the load instruction to complete all of the pipeline stages and actually write to the FPR in order to access the loaded data. Referring back to the previous sample instruction stream, the fmadd instruction 1.2 may receive the data loaded by the load instruction 1.1 via the first feedback path going from the output of the data one register 104 to the input of the multiplexer 102. If an arithmetic instruction and a load instruction were separated by one intervening instruction, then the second feedback path going from the output of the data two register 108 to the input of the multiplexer 102.

FIG. 1 depicts a feedback path from every stage of the pipeline for load execution. This allows an arithmetic instruction (e.g., fmadd instruction 1.2) to start immediately after a load instruction (e.g., lfd instruction 1.1). One drawback to this approach is that it creates many wires that may be very long. Due to steadily increasing processor clock rates, however, and the resulting shorter cycles, and due to the existence of 64-bit addresses instead of 32-bit addresses, the need may arise to avoid such wiring, as it leads to long signal lines, which may in turn require line amplifiers. Another drawback to the approach depicted in FIG. 1 is that is does not solve the problem of allowing a second load (e.g., lfd instruction 2.1) to start before a first arithmetic instruction writing to the same register (e.g., fmadd instruction 1.2) completes. In other words, the scheme does not solve the write after write (WAW) problem introduced by performing early loads.

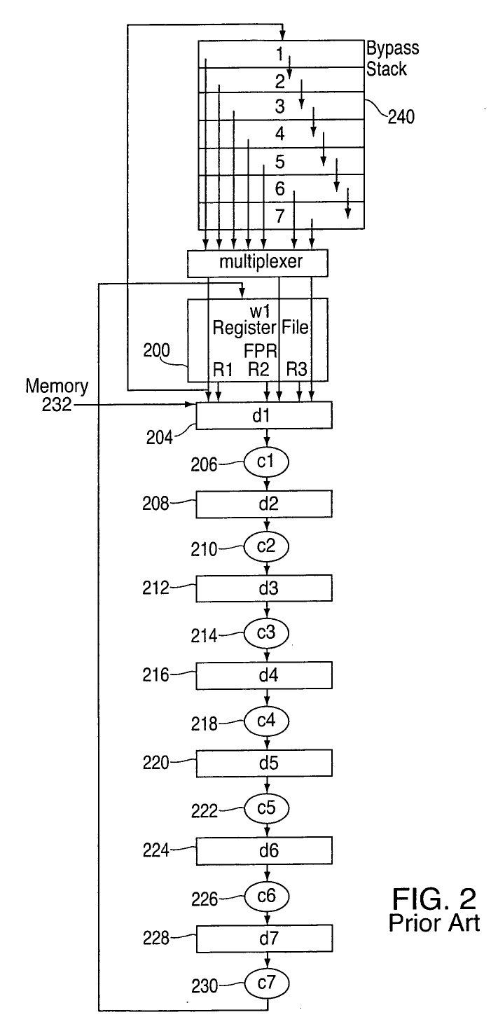

FIG. 2 depicts another seven stage pipeline that has been utilized by prior art to allow arithmetic instructions to be executed one or more cycles after a dependent load instruction enters the pipeline. See, for example, U.S. publication No. 2004/0143616 to Clemen et al., of common assignment herewith. The pipeline depicted in FIG. 2 provides the same functions as those described in reference to FIG. 1 but without the extra wiring for the feedback paths. Instead of the feedback paths, a bypass stack 240 is utilized. When data is being loaded into the register file 200 from memory 232, the data is also fed into the bypass stack 240. The data is not actually being written to the FPR early but instead being saved in the stack. Input data from any of the positions in the stack may be provided, via the multiplexer 202, into a data one register 204 for use as an input operand to subsequent instructions. In this manner, subsequent instructions have access to load operands while they are being staged through the pipeline before they appear in the register file 200.

As depicted in FIG. 2, instructions are received (e.g., from a control unit) into a register file 200. The pipeline includes a typical seven stage pipeline with a data one register 204, combinatorial logic one 206, a data two register 208, combinatorial logic two 210, a data three register 212, combinatorial logic three 214, a data four register 216, combinatorial logic four 218, a data five register 220, combinatorial logic five 222, a data six register 224, combinatorial logic six 226, a data seven register 228, and combinatorial logic seven 230. The pipeline flow includes data from the register file 200, data from memory 232 and data from a multiplexer 202 entering the data one register 204.

FIG. 2 depicts a bypass stack to provide access to load operands as they are being staged through the pipeline via a bypass stack 240. This method reduces wire lengths as compared to the system depicted in FIG. 1. The use of a bypass stack allows an arithmetic instruction (e.g., fmadd instruction 1.2) to start immediately after a load instruction (e.g., lfd instruction 1.1). A drawback to the approach depicted in FIG. 2 is that is does not solve the problem of allowing a second load (e.g., lfd instruction 2.1) to start before a first arithmetic instruction writing to the same register completes (e.g., fmadd instruction 1.2). In other words, the scheme does not solve the write after write (WAW) problem introduced by performing early loads.

Another approach to executing floating point loads in a pipeline while still being allowed to start dependent instructions includes register renaming with early write. This would solve the problem of executing a load to FMADD forwarding, as well as the WAW hazard of the second load. However, this approach is very complex and requires hardware to scoreboard instruction execution. It is better suited to a full out-of-order execution design and is not to a limited out-of-order execution design as described herein.

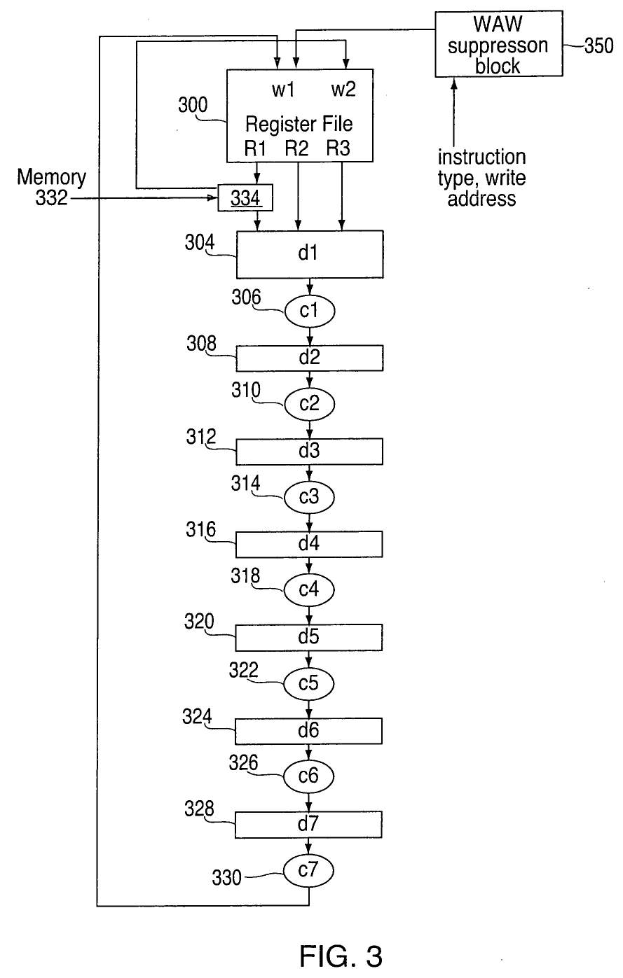

FIG. 3 depicts an exemplary pipeline that may be utilized by exemplary embodiments of the present invention to allow load instructions to be executed early in the pipeline and to prevent a WAW from occurring. As shown by the inputs and outputs to a multiplexer 334, when data from memory 332 is written to the data one register 304, it is also written to the register file 300. In this manner, the FPR is updated with the loaded data from memory 332 during the first stage of the pipeline. Then, if a subsequent instruction is dependent on the load operation, the subsequent instruction does not have to wait until stage seven has been completed to start execution. In addition, a WAW suppression block 350 keeps track of the FPRs that have been written to by early load instructions currently in the stack. This is utilized to prevent overwriting newly loaded data, which has been written to the FPR in an early cycle, with the results of an arithmetic instruction. If the FPR is located in the stack, then the write to the FPR from the arithmetic instruction is suppressed. In this manner WAW can be avoided.

As depicted in FIG. 3, instructions are received (e.g., from a control unit) into a register file 300. The pipeline includes a typical seven stage pipeline with a data one register 304, combinatorial logic one 306, a data two register 308, combinatorial logic two 310, a data three register 312, combinatorial logic three 314, a data four register 316, combinatorial logic four 318, a data five register 320, combinatorial logic five 322, a data six register 324, combinatorial logic six 326, a data seven register 328, and combinatorial logic seven 330. The pipeline flow includes data from the register file 300 and data from memory 332 entering the data one register 304 for use as instruction operands. In addition, input to the WAW suppression block 350 includes instruction type and write address from the control unit at the same time that the instruction is being sent to the register file 300 for execution. Alternatively, the instruction type and write address may be received from the register file 300.

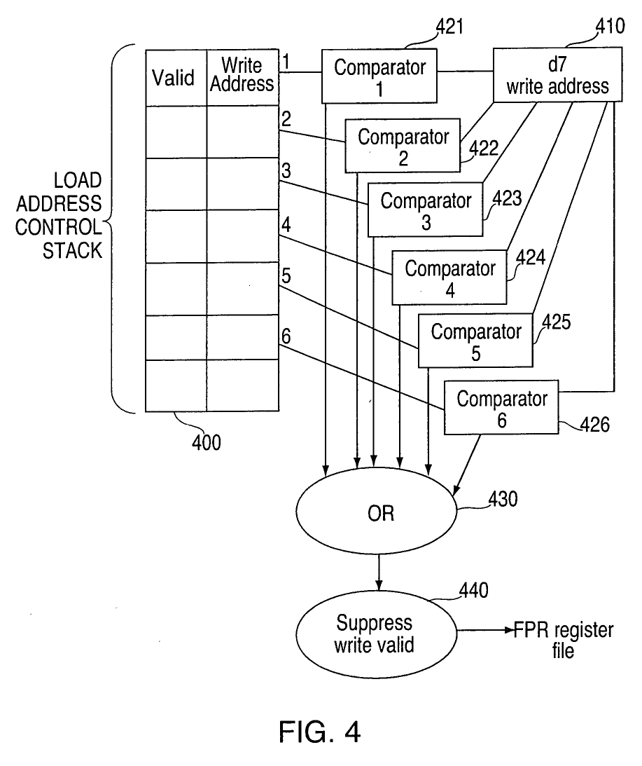

FIG. 4 depicts an exemplary WAW suppression block 350 that may be utilized by exemplary embodiments of the present invention. The WAW suppression block 350 includes a load address control stack 400 that includes the load addresses (i.e. corresponding to the FPRs) for any load instructions that were loaded early and are currently in all but the last stage of the pipeline. Every time that a load instruction is executed, its load address is entered into this stack. At each cycle, the load address corresponding to the load instruction moves down in the stack to correspond to the current stage of the load instruction. When an arithmetic instruction (e.g., FMADD, multiply) is about to perform a write to a FPR (e.g., at stage 7 in the pipeline), a check is made to determine if the FPR has been utilized by a more recent load instruction that was loaded early into the FPR. The arithmetic write address 410 (e.g., “d7 write address” if the write occurs after cycle 7 as depicted in FIG. 3) is compared to the write addresses in the load address control stack 400.

Several comparators (e.g., Comparator 1 421, Comparator 2 422, Comparator 3 423, Comparator 4 424, Comparator 5 425 and Comparator 6 426 in FIG. 4) are utilized to compare the arithmetic write address 410 to the values in the load address control stack 400. Each of the comparators outputs a one if a match is found and a zero if a match is not found. The outputs of the comparators are input to “or” gate 430. The output of the “or” gate 430 is input to the suppress write valid block 440. The output of the suppress write valid block 440 sends a write suppress signal equal to one (i.e. suppress the write from the arithmetic instruction) to the register file 300 if the arithmetic write address 410 was found in the load data control stack 400. The output of the suppress write valid block 440 sends a write suppress signal equal to zero (i.e. do not suppress the write from the arithmetic instruction) to the register file 300 if the arithmetic write address 410 was not found in the load data control stack 400.

Referring back to the sample instruction stream described previously, this allows both the fmadd instruction 1.2 to immediately follow the lfd instruction 1.1 and for the second lfd instruction 2.1 to be started before the previous fmadd instruction 1.2 has completed. The lfd instruction 1.1 stores the value of mem1 into FPR5 during the first stage in the pipeline as depicted in FIG. 3. Therefore, the fmadd instruction 1.2 finds a valid value in FPR5 during its first stage in the pipeline. When the second lfd instruction 2.1 enters the pipeline and stores the value of “mem1+disp” into FPR5, the fmadd instruction 1.2 is in stage 3 of the pipeline. When the fmadd instruction 1.2 attempts to write to FP5 during stage 7, the write suppress signal is equal to one because FP5 will be found in the fifth entry of load data control stack 400. This fixes the WAW problem by preventing the results of the fmadd instruction 1.2 from overwriting the new data value loaded in to FP5 by the lfd instruction 2.1.

Exemplary embodiments of the present invention may be extended to include pipelines of other sizes, the early load to the register occurring in a cycle other than the first cycle, and the write by the arithmetic instruction occurring in a cycle other than the last cycle.

Exemplary embodiments of the present invention assist in optimizing the execution of floating point loads in a floating point pipeline. The design is to modify an in-order execution machine to be slightly out-of-order and to create a mechanism for suppressing WAW hazards. Exemplary embodiments of the present invention allow only loads to be executed out-of-order and reduce the wiring that would be required in an in-order machine with many bypasses. In addition, the WAW hazard mechanism suppresses arithmetic instruction writes but allows their feedback paths to dependent instructions to be maintained.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention, can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A system for performing limited out-of-order execution of floating point loads, the system comprising:
a plurality of stages making up a pipeline, the stages including an early stage; and
a mechanism for:
inputting an arithmetic instruction into the pipeline, the arithmetic instruction including a result address;
determining if the arithmetic instruction causes a write after write (WAW) condition to occur before writing a result of the arithmetic instruction to the result address, the determining including:
comparing the result address to a load address associated with a load instruction subsequent to the arithmetic instruction in the pipeline, wherein load data associated with the load instruction was written to the load address in the early stage of the pipeline and a WAW condition occurs if the result address is equal to the load address; and
suppressing the writing a result of the arithmetic instruction in response to the WAW condition occurring.

2. The system of claim 1 wherein the load address is stored in a stack that tracks the load instruction location in the pipeline.

3. The system of claim 1 wherein all instructions in the pipeline execute in order except for the load instruction.

4. The system of claim 1 wherein the early stage is the first stage in the pipeline.

5. The system of claim 1 wherein the load address corresponds to a floating point register.

6. The system of claim 1 wherein the result address corresponds to a floating point register.

7. The system of claim 1 wherein the pipeline includes seven stages.

8. A method for performing limited out-of-order execution of floating point loads, the method comprising:
inputting an arithmetic instruction into a pipeline, wherein the arithmetic instruction includes a result address and the pipeline includes a plurality of stages including an early stage;
determining if the arithmetic instruction causes a write after write (WAW) condition to occur before writing a result of the arithmetic instruction to the result address, the determining including:
comparing the result address to a load address associated with a load instruction subsequent to the arithmetic instruction in the pipeline, wherein load data associated with the load instruction was written to the load address in the early stage of the pipeline and a WAW condition occurs if the result address is equal to the load address; and
suppressing the writing a result of the arithmetic instruction in response to the WAW condition occurring.

9. The method of claim 8 wherein the load address is stored in a stack that tracks the load instruction location in the pipeline.

10. The method of claim 8 wherein all instructions in the pipeline execute in-order except for the load instruction.

11. The method of claim 8 wherein the early stage is the first stage in the pipeline.

12. The method of claim 8 wherein the load address corresponds to a floating point register.

13. The method of claim 8 wherein the result address corresponds to a floating point register.

14. The method of claim 8 wherein the pipeline includes seven stages.
